(19) United States
(12) Patent Application Publication
(10) Pub. No.: US 2012/0184645 A1
(43) Pub. Date: Jul. 19, 2012

(54) RESINOUS DISPERSIONS INCLUDING AN EPOXY AMINE ADDUCT FOR FLATTING AND RELATED ELECTRODEPOSITABLE COATING COMPOSITIONS

(75) Inventors: Joseph T. Valko, Pittsburgh, PA (US); James Poole, Gibsonia, PA (US); Mike Grindland, Allison Park, PA (US)

(73) Assignee: PPG Industries Ohio, Inc., Cleveland, OH (US)

(21) Appl. No.: 13/005,569

(22) Filed: Jan. 13, 2011

(51) Int. Cl. C08L 63/02

(52) U.S. Cl. 523/415; 523/414

(57) ABSTRACT

Disclosed herein are resinous dispersions suitable for use in an electrodepositable coating composition. The resinous dispersions include: (a) an epoxy-amine adduct formed as the reaction product of reactants comprising (i) an epoxy-containing compound having at least one active hydroxyl group; and (ii) an amine-containing compound having a primary and a tertiary amine group; (b) an acid; (c) a second epoxy-containing compound; and (d) water. The resinous dispersion may be introduced into cationic electrodepositable coating compositions. Coated substrates formed with such cationic electrodepositable coating compositions may achieve 60° gloss readings of 3 or less at conventional film builds.

### STATEMENT REGARDING FEDERALLY SPONSORED RESEARCH

This invention was made with Government support under Contract No. W15QKN-07-C-0048 awarded by the ARDEC. The United States Government may have certain rights in this invention.

### FIELD OF THE INVENTION

The present invention relates to resinous dispersions, coating compositions, multi-component composite coatings, and related coated substrates.

### BACKGROUND INFORMATION

Electrodeposition as a coating application method involves the deposition onto a conductive substrate of a film-forming composition under the influence of an applied electrical potential. Electrodeposition has gained popularity in the coatings industry because it provides higher paint utilization, outstanding corrosion resistance, and low environmental contamination as compared with non-electrophoretic coating methods. Both cationic and anionic electrodepositions are used commercially, with cationic being more prevalent in applications desiring a high level of corrosion protection. Anionic electrodeposition is typically used for decorative applications, particularly where low cost and decorative qualities such as gloss and color are desired. Electrodepositable cationic acrylic vehicles with optional minor amounts of cationic epoxy may be used for applications in which both decorative and anti-corrosion properties are desirable.

There are a number of applications in which it is desired to control the gloss of a coating layer applied by electrodeposition. For example, it is highly desirable to control the gloss of the coating layer in military applications, such as for use in munitions applications. Electrodepositable coating compositions having high gloss levels are readily achievable, but compositions with a low gloss level that is retained after exterior exposure have been very hard to prepare. Addition of traditional flatting agents such as silicas and alumina silicates to electrodepositable coating compositions will produce the desired gloss levels initially, but the finishes discolor and chalk quickly upon exposure to the elements. Furthermore, traditional flatting agents are often much more dense than other bath components and will settle in the electrocoat baths; continuous recirculation must therefore be employed to maintain paint homogeneity, even when the bath is not in use. The need for continuous recirculation can lead to higher capital equipment costs, higher maintenance costs, and higher energy costs.

Another related issue with these low gloss electrocoat systems that use traditional flatting agents is that the application of these electrocoat compositions on irregularly shaped or complex shaped parts results in areas of lower gloss and areas of higher gloss, particularly on surfaces of the part that have a different orientation in the bath (horizontally oriented vs. vertically oriented, for example).

It is therefore highly desirable to provide an electrocoat system that addresses at least some of the deficiencies discussed above.

### SUMMARY OF THE INVENTION

One exemplary embodiment of the present invention discloses a resinous dispersion suitable for use in an electrodepositable coating composition comprising: (a) an epoxy-amine adduct comprising the reaction product of reactants comprising (i) an epoxy-containing compound having at least one active hydroxyl group; and (ii) an amine-containing compound having a primary and a tertiary amine group; (b) an acid; (c) a second epoxy-containing compound; and (d) water.

A related exemplary embodiment comprises an electrodepositable coating composition comprising the resinous dispersion as described in the previous paragraph, a cationic curable film-forming binder, a catalyst and, optionally, a colorant.

Other related exemplary embodiments disclose multi-component composite coatings, coated substrates, and methods for coating a substrate.

### DETAILED DESCRIPTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

As previously mentioned, certain embodiments of the present invention provide an electrodepositable coating composition, and associated method for forming all or portions thereof, that can, in at least some cases, be used to form an electrodeposited coating layer that can induce 60° gloss readings of 3 or less (i.e. a reduced-gloss appearance or “flatting effect”) on all its coated surfaces, regardless of their orientation while being coated in the elecrodeposition bath, and at conventional film thicknesses, without the use of traditional flatting pigments such as silicas and alumina silicas.

The present invention can find particular use for coating multiple sides of a complex shaped part or article (i.e. a part or article that is not flat, or multi-sided part) in a single electrodeposition application step, wherein each of the coated sides, after cure, has a similar desired flatting effect (i.e. exhibits 60° gloss readings of 3 or less) at conventional film thicknesses. Thus, for example, a multi-shaped part (such as an L-shaped part) with horizontal and vertical surfaces may be coated in a single-stage conventional electrodeposition bath to provide a cured coating on each of the surfaces at conventional film thicknesses that exhibits a 60° gloss reading of 3 or less.

One exemplary application is for military applications, wherein low-gloss finishes are required for munitions and for many military vehicles. Munitions, as defined herein, is used in the broadest sense of the term to cover anything that can be used in combat that includes but is not limited to bombs, missiles, warheads, and mines. Military vehicles may include, but are not limited to, land, combat and transportation vehicles.

In certain embodiments, the electrodepositable coating composition comprises a resinous dispersion (also referred to herein as “flatting agent dispersion” or “flatting agent resinous dispersion”), a cationic film-forming binder, a curing agent, and, optionally, a colorant.

In an exemplary embodiment of the present invention, the resinous dispersion comprises: (a) an epoxy-amine adduct comprising the reaction product of reactants comprising (i) an epoxy-containing compound having at least one active hydroxyl group; and (ii) an amine-containing compound having a primary and a tertiary amine group, (b) an acid; (c) a second epoxy-containing compound; and (d) water.

Suitable epoxy-containing compounds having at least one hydroxyl group (i) include, for example, bisphenol A diglycidyl ether compounds having an epoxy equivalent weight, based on the resin solids and prior to the addition of the amine-containing compound (ii), from 400-1300 gm/equivalent of epoxy. In some cases, such bisphenol A diglycidyl ether compounds have an epoxy equivalent weight, based on the resin solids, from 400-700 gm/equivalent of epoxy. One exemplary bisphenol A diglycidyl ether compound is EPON 1001, having an epoxy equivalent weight from 450 to 550 gm/equivalent of epoxy, based on resin solids, available from Hexion Specialty Chemicals. Other non-limiting examples of suitable epoxy-containing compounds (i) having at least one hydroxyl group are novolac epoxy resins such as EPON Resin 160 (EEW of 168-178), available from Hexion Specialty Chemicals, which has been reacted with a material such as bisphenol A, bisphenol F or a dicarboxylic acid such that it contains at least one hydroxyl group.

In one embodiment, the epoxy-containing compound (i) having at least one hydroxyl group is formed from the reaction product of reactants comprising a diepoxide and an adduct, wherein the adduct comprises the reaction product of reactants comprising a polyol and an anhydride of a diacid. In certain embodiments, this reaction occurs in the presence of a catalyst and an organic solvent.

Suitable polyols include diols and higher functional alcohols such as, for example. ethoxylated bisphenol A homologs, polyethylene oxide diols, polypropylene oxide diols, 1,6-hexanediol, trimethylopropane, ethoxylated trimethylolpropane, propoxylated trimethylolpropane, pentaerythritol, ethoxylated pentaerythritol, propoxylated pentaerythritol, including combinations thereof.

Suitable anhydrides of a diacid include, for example, hexahydrophthalic anhydride, maleic anhydride, succinic anhydride, phthalic anhydride, and combinations thereof.

Suitable diepoxides include, for example, bisphenol A diglycidyl ether and copolymers thereof with bisphenol A, bisphenol F diglycidyl ethers, novolac epoxies, epoxidized polybutadienes, and combinations thereof.

In one embodiment, the epoxy-containing compound having at least one active hydroxyl group (i) comprises an epoxy-containing compound according to Formula (I):

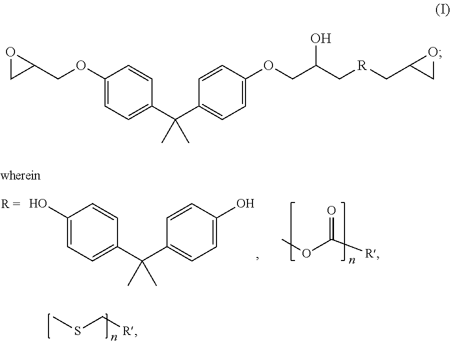

and/or combinations thereof;

R′ is aliphatic, cycloaliphatic and/or aryl and comprises an ester, a urethane and/or ether linkage; and

n is from 1 to 3.

In some embodiments, the epoxy-amine adduct (a) has a structure according to Formula (II):

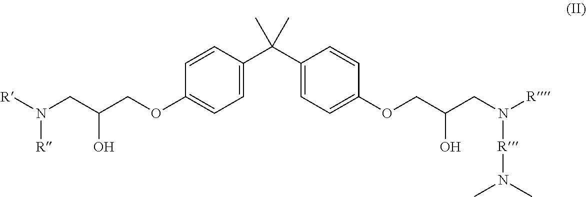

wherein R′ is H, —CH₂—CH₂—OH, —CH₂CH₂NH₂, —CH₂—CH(CH₃)—OH, or —(CH₂)_{R1}CH₃, where R1 is from 0 to 9; wherein R″ is —CH₂—CH₂—OH, —CH₂CH₂NH₂, or —CH₂—CH(CH₃)—OH; R′″ is —(CH₂)_{R2}CH, where R2 is from 1 to 9; and wherein R″″ is R′, R″ or

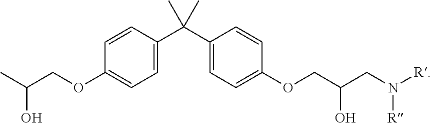

Suitable amine-containing compounds (ii) having a primary and a tertiary amine group that may be utilized include, for example, dimethylaminopropylamine, 2-dimethylaminoethylamine, 4-dimethylaminobutylamine, 6-dimethylaminohexylamine, and dimethylaminomethylaniline, including combinations thereof.

In one embodiment, the weight percent of amine-containing compounds (ii) comprises from 0.4 to 7%, based on resin solids, of the resinous dispersion.

In another embodiment, the amine-containing compounds (ii) comprises dimethylaminopropylamine and comprises from 0.4 to 7.0 weight percent, such as from 1.5 to 3.0 weight percent, based on resin solids, of the resinous dispersion.

In yet another embodiment, the reactants used to form the epoxy-amine adduct (a) further comprises (iii) at least one additional amine-containing compound. Suitable additional amine-containing compound include N-methylethanolamine, ethanolamine, diethanolamine, morpholine, 3-methoxy-1-propylamine, 4-methyl-2-pentanone diketimine of diethylenetriamine, and aniline, including combinations thereof.

In one embodiment, the weight percent of at least one additional amine-containing compound comprises from 0.4 to 7%, based on resin solids, of the resinous dispersion.

Suitable acids (b) that may be used include aqueous acid solutions such as those containing sulfamic acid, acetic acid, formic acid, or lactic acid, including combinations thereof. Preferably, the weight range of aqueous acid in the resinous dispersion is from 0.5 to 13 weight percent, and more preferably from 0.8 to 7.0 weight percent, based on resin solids of the resinous dispersion.

Suitable epoxy containing compounds (c) (i.e. the second epoxy compound (c)) include epoxy containing compounds having an epoxy equivalent weight (“EEW”) from 165 to 1000 gm/equivalent of epoxy, based on resin solids. These compounds may be the same as the diepoxide as described above that forms the epoxy-containing compound having an active hydroxyl group (i) or different from (i). Exemplary epoxy containing compounds (c) that may be used include bisphenol A diglycidyl ether (EEW of 188), bisphenol A diglycidyl ether which has been advanced with additional bisphenol A or other epoxy-reactive species, glycidyl (meth)acrylate-containing acrylic copolymers containing on average more than one epoxy group, novolac epoxies having an EEW from 168 to 178, and epoxidized polybutadienes, including combinations thereof.

As noted above, in another embodiment, an electrodepositable composition utilizing the resinous dispersion may be formed and includes a cationic film forming resin, a curing agent, and, optionally, a colorant. The amount of resinous dispersion included in the electrodepositable composition is ultimately determined by the degree of flatting desired, and may range from 1 to 40 or more weight percent of the total weight of the electrodepositable composition, based on resin solids. In the examples provided below, for example, a 60° gloss reading of 3 or less was achieved in certain embodiments utilizing 20 weight percent of the resinous dispersion in an electrodepositable composition at conventional film builds.

Suitable cationic film-forming resins that may be used in the electrodepositable coating composition preferably include a degree of incompatibility with the resinous dispersion to induce a flatting effect. One such cationic film-forming resin is an acrylic-sulfonium resin. In particular, in one exemplary embodiment, the use of an acrylic backbone resin, such as in an acrylic sulfonium resin, provides a degree of incompatibility with the resinous dispersion to induce flatting in the electrocoat formulation by formation of domains.

Suitable curing agents include, but are not limited to, blocked or unblocked isocyanates such as those described in Column 7, line 5 to Column 8, line 7 of U.S. Pat. No. 5,820,987 to Kaufman et. al., assigned to PPG Industries, Inc., the cited portion of which being herein incorporated by reference. More specific curing agents that may be utilized include, for example, IPDI/TMP/Dowanol PM/MEK oxime crosslinker, IPDI/TMP/2-butoxyethanol, IPDI/TMP/caprolactam/1-methoxy-2-propanol, methylene-bis-(4-isocyantocyclohexane)/1,2-butane diol, TDI/TMP/benzyl alcohol, HMDI/TMP/MEK oxime, and/or MDI/TMP/2-butoxyethanol.

In addition, a colorant and, if desired, various additives such as surfactants or wetting agents can be included in the coating composition comprising a film-forming resin. As used herein, the term “colorant” means any substance that imparts color and/or other opacity and/or other visual effect to the composition. The colorant can be added to the composition in any suitable form, such as discrete particles, dispersions, solutions and/or flakes. A single colorant or a mixture of two or more colorants can be used.

Example colorants include pigments, dyes and tints, such as those used in the paint industry and/or listed in the Dry Color Manufacturers Association (DCMA), as well as special effect compositions. A colorant may include, for example, a finely divided solid powder that is insoluble but wettable under the conditions of use. A colorant can be organic or inorganic and can be agglomerated or non-agglomerated. Colorants can be incorporated by use of a grind vehicle (or pigment paste), such as an acrylic grind vehicle, the use of which will be familiar to one skilled in the art.

Example pigments and/or pigment compositions include, but are not limited to, carbazole dioxazine crude pigment, azo, monoazo, disazo, naphthol AS, salt type (lakes), benzimidazolone, condensation, metal complex, isoindolinone, isoindoline and polycyclic phthalocyanine, quinacridone, perylene, perinone, diketopyrrolo pyrrole, thioindigo, anthraquinone, indanthrone, anthrapyrimidine, flavanthrone, pyranthrone, anthanthrone, dioxazine, triarylcarbonium, quinophthalone pigments, diketo pyrrolo pyrrole red (“DPPBO red”), titanium dioxide, carbon black and mixtures thereof. The terms “pigment” and “colored filler” can be used interchangeably.

Example dyes include, but are not limited to, those that are solvent and/or aqueous based such as phthalo green or blue, iron oxide, bismuth vanadate, anthraquinone, perylene, aluminum and quinacridone.

Example tints include, but are not limited to, pigments dispersed in water-based or water miscible carriers such as AQUA-CHEM 896 commercially available from Degussa, Inc., CHARISMA COLORANTS and MAXITONER INDUSTRIAL COLORANTS commercially available from Accurate Dispersions division of Eastman Chemical, Inc.

As noted above, the colorant can be in the form of a dispersion including, but not limited to, a nanoparticle dispersion. Nanoparticle dispersions can include one or more highly dispersed nanoparticle colorants and/or colorant particles that produce a desired visible color and/or opacity and/or visual effect. Nanoparticle dispersions can include colorants such as pigments or dyes having a particle size of less than 150 nm, such as less than 70 nm, or less than 30 nm. Nanoparticles can be produced by milling stock organic or inorganic pigments with grinding media having a particle size of less than 0.5 mm. Example nanoparticle dispersions and methods for making them are identified in U.S. Pat. No. 6,875,800 B2, which is incorporated herein by reference. Nanoparticle dispersions can also be produced by crystallization, precipitation, gas phase condensation, and chemical attrition (i.e., partial dissolution). In order to minimize re-agglomeration of nanoparticles within the coating, a dispersion of resin-coated nanoparticles can be used. As used herein, a “dispersion of resin-coated nanoparticles” refers to a continuous phase in which is dispersed discreet “composite microparticles” that comprise a nanoparticle and a resin coating on the nanoparticle. Example dispersions of resin-coated nanoparticles and methods for making them are identified in United States Patent Application Publication 2005-0287348 A1, filed Jun. 24, 2004, U.S. Provisional Application No. 60/482,167, filed Jun. 24, 2003, and U.S. patent application Ser. No. 11/337,062, filed Jan. 20, 2006, which we also incorporated herein by reference.

Example special effect compositions that may be used include pigments and/or compositions that produce one or more appearance effects such as reflectance, pearlescence, metallic sheen, phosphorescence, fluorescence, photochromism, photosensitivity, thermochromism, goniochromism and/or color-change. Additional special effect compositions can provide other perceptible properties, such as opacity or texture. In certain embodiments, special effect compositions can produce a color shift, such that the color of the coating changes when the coating is viewed at different angles. Example color effect compositions are identified in U.S. Pat. No. 6,894,086, incorporated herein by reference. Additional color effect compositions can include transparent coated mica and/or synthetic mica, coated silica, coated alumina, a transparent liquid crystal pigment, a liquid crystal coating, and/or any composition wherein interference results from a refractive index differential within the material and not because of the refractive index differential between the surface of the material and the air.

In general, the colorant can be present in the coating composition in any amount sufficient to impart the desired visual and/or color effect. The colorant may comprise from 1 to 65 weight percent, such as from 3 to 40 weight percent or 5 to 35 weight percent, with weight percent based on the total weight of the electrodepositable coating composition.

To form the resinous dispersion according to one exemplary embodiment, a first epoxy compound (i) is added to a reaction vessel equipped with a mechanical stirrer and condenser, along with bisphenol A and organic solvents such as methyl isobutyl ketone, and optionally with an adduct that is formed from the reaction product of a polyol and hexahydrophthalic anhydride, and heated for a period of time sufficient to extend the first epoxy compound (i) to its desired epoxy equivalent weight (from 400 to 1300), based on resin solids. Next, the amine-containing compound (ii) is added to the extended first epoxy compound (i), and optionally with an additional amine-containing compound, and the resultant mixture is heated to a temperature sufficient to react the amine-containing compound (ii) to the epoxy containing compound (i) to form the epoxy-amine adduct (a).

Next, the epoxy-amine adduct (a) is dispersed in an acid (b), such as an aqueous acid (b), and reduced to a desired solids content with water (d). At this point, the resultant dispersion is still a “water-in-oil” dispersion (that is, before its inversion point). At this point, the second epoxy compound (c) is co-solubilized in the dispersion. After mixing, more water (d) is added to dilute the dispersion through its inversion point and beyond, wherein it becomes an “oil-in-water” dispersion. The dispersion may be characterized wherein microscopic spheres of resin, known as micelles, are dispersed in a sea of water. Next, the volatile organic solvents can be removed by steam distillation under a vacuum, otherwise known as stripping. The resultant mixture may then be heat aged. Since the additional unreacted second epoxy compound (c) is added before its inversion point, it is present in the micelles. Moreover, since the amine-containing compound (ii) is chemically attached to the first epoxy compound (i), it cannot be extracted into the water phase, and can therefore serve as a catalyst for the subsequent hydroxyl/epoxy interactions that occur as the material is heat aged.

As the second epoxy compound (c) reacts during heat aging, the molecular weight of the resin increases. This process can continue due to the presence of the amine-containing compound (ii), which remains active as a catalyst, until all of the available epoxy groups have been consumed. If sufficient second epoxy compound (c) has been co-solubilized, this process can continue to the point of gelation, but since the resin is in such a dispersed state, the result is a cationic dispersion of gelled micelles. This progression of gel formation can be followed by a simplified gel fraction test (described below), until about 90% of the resin solids appear to have gelled (i.e. has a relative gel fraction of about 90% after heat aging).

For the purposes of the present invention, a simplified gel fraction test is performed as follows. First, in each of three, 2.5 in (64 mm) diameter, weighed aluminum foil weighing dishes, a 0.5000-0.6000 gm quantity of the aqueous resinous dispersion is dispensed and the weight recorded. Each sample is diluted with deionized or distilled water such that the total completely covered the bottom of the weighing dish with the uniform dispersion. The dishes are placed for one hour in an electrically-heated convection oven set to 110° C. At the end of the hour, the dishes are reweighed. In turn, to the residue in each of the dishes is added about 5 grams of 1-methoxy-2-propanol. The dishes are then heated on a hot plate set to 60°-70° C. for 5 minutes. After the 5 minutes, the solvent is decanted and promptly replaced with another 5 grams of fresh 1-methoxy-2-propanol. After another 5 minutes on the hot plate, the solvent is decanted and a third portion of 5 grams of solvent was added. After this third 5 minutes on the hot plate, the solvent is decanted and the dishes are returned to the same oven for a one hour bake. After this bake, the dishes are again weighed. The averaged mass of the residue remaining in two of the dishes (omitting the highest weight loss dish) after the second bake over that in the dishes after the first bake is interpreted as the gel fraction, which is expressed in terms of a percentage by weight. For example, a gel fraction of 88% after heat aging means that 88% of the solids of the initial dispersion remained on the weighing dish after the second bake.

The resultant dispersion, in another embodiment, may then be introduced into an electrocoat formulation having a cationic film forming binder such as acrylic-sulfonium, a curing agent, and a pigment paste. Conductive panels coated with such an electrocoat formulation via a conventional electrodeposition coating process, as shown in the examples below, can, in at least some cases, exhibit a 60° gloss of 3 or less on one or more surfaces of a multisided substrate at conventional film builds in a single step process, regardless of the respective surface's orientation within the bath during the coating process.

### Example 1

This example describes the preparation of a cationic electrodeposition coating with a flatting agent resinous dispersion in accordance with an exemplary embodiment of the present invention, as well as a comparison of the resultant electrodepositable coating composition to another electrodepositable coating composition utilizing traditional flatting pigments.

### Part A: Preparation of Flatting Agent Resinous Dispersion

Subpart 1: Preparation of Epoxy-Amine Adduct—A 3000 ml round-bottomed 4-neck flask was equipped with a stirrer with bearing, a water-cooled condenser, a thermocouple probe with nitrogen inlet adapter and an electrically-heated mantle. The flask was charged with 586.5 parts (3.120 equiv.) of bisphenol A diglycidyl ether (equivalent weight 188), 188.7 parts (1.655 equiv.) of bisphenol A and 116.2 parts of an adduct made by adding 776.8 parts ethanolamine to 1323.1 parts of propylene carbonate over 2 hours at 70° C., followed by an additional 7 hours at 70° C. Under a nitrogen blanket, this was stirred and heated to 115° C. At 115° C., 2.8 parts of ethyl triphenylphosphonium iodide (available from Sigma-Aldrich) was added. This was heated until an exotherm began, and the reaction mixture was maintained at or above 165° C. for 90 minutes. After 90 minutes, 207.1 parts of methyl isobutyl ketone was cautiously added to dilute and cool the mixture to 95° C. At 95° C., 54.4 parts of a 70% solution of the methyl isobutyl ketone diketimine of diethylene triamine in excess methyl isobutyl ketone and 24.6 parts of 3-dimethylamino-1-propylamine were added. This was heated to 120° C. and held for 90 minutes. At the end of the 90 minutes, 219.6 parts of 1-methoxy-2-propanol was added and mixed to homogeneity.

Subpart 2: Preparation of Extended Epoxy Compound—A 3000 ml round-bottomed 4-neck flask equipped as above was charged with 926.6 parts of bisphenol A diglycidyl ether, 268.8 parts bisphenol A, 19.1 parts of 2,5-dimercapto-1,3,4-thiadiazole (available from Acros Organics/Fisher Scientific International Inc.), and 236.9 parts of 2-butoxyethanol. The mixture was stirred and heated to 115° C. At 115° C., 1.9 parts of ethyl triphenylphosphonium iodide was added and heating was continued until an exotherm occurred. This reaction mixture was maintained at a minimum of 165° C. for an hour. At the end of the hour, 146.7 parts of 1-methoxy-2-propanol was added cautiously and the resin solution was allowed to cool, therein forming an advanced epoxy resin. The solids content was determined to be 77.4% and the epoxy equivalent weight adjusted for solids was 722.

Subpart 3: Preparation of Flatting Agent Resinous Dispersion—1200 parts of the Epoxy-Amine Adduct of Subpart 1 was dispersed into a mixture of 29.3 parts of glacial acetic acid and 438.8 parts of deionized water with good agitation. About 15 minutes after completion of the dispersion, 105.4 parts of extended epoxy compound from Subpart 2 above and 80.1 parts of bisphenol A diglycidyl ether (0.426 equiv.) were added. This was mixed for 30 minutes. Next, a total of 1669.9 parts of deionized water was added gradually in portions. The organic solvents were removed under reduced pressure and replenished with deionized water to yield a dispersion at 27.9% solids.

### Part B: Preparation of Electrodepositable Coating Composition

An electrodepositable coating composition from the Flatting Agent Resinous Dispersion of Part A was prepared as follows:

| | | |
|---|---|---|
| Resin blend¹ | 464.3 | g |
| Flatting agent from Part A | 97.8 | g |
| Pigment paste² | 198.8 | g |
| Deionized water | 1139 | g |

¹Cationic resin blend commercially available as CR935 from PPG Industries, Inc.
²A pigment paste which contains 26.5 g of pigments, none of which contain silica, and 30.0 g of grind vehicle.

The above ingredients were combined and the resulting paint had a solids content of about 15% and a P/B ratio of 0.151. The electrocoating composition was ultrafiltered thirty percent by weight and replenished with deionized water.

### Part C: Preparation of Conventional Flatted Coating

This example describes the preparation of a cationic electrodeposition paint containing a pigment paste containing sufficient treated silica as to produce a flat coating with a 60° gloss reading under 3 at conventional film builds:

| | | |
|---|---|---|
| Resin blend¹ | 559.6 | g |
| Flow Additive² | 29.2 | g |
| Pigment paste³ | 209.3 | g |
| Deionized water | 1102 | g |

¹Cationic resin blend commercially available as CR935 from PPG Industries, Inc.
²Commercially available as CA147 Flow Additive from PPG Industries, Inc.
³A pigment paste containing 53.0 gm of pigments comprising commercially-available treated silica and 35.1 gm of grind vehicle

The above ingredients were combined and the resulting paint had a solids content of about 15% and a P/B ratio of 0.302. The electrodepositable coating composition was ultrafiltered thirty percent by weight and replenished with deionized water.

### Part D: Coating Parameters and Panel Type Used for Coat Outs

The steel panels used for the electrocoating of this paint formulation are available from ACT Test Panels LLC of Hillsdale, Mich. as part number APR33225.

The panels are ACT Cold Roll Steel and are 4 inches×12 inches×0.032 inches. They are prepared with B952 P90 DIW.

The cylindrical plastic coating tube 4¾ inches diameter and 15 inches height was equipped with a magnetic stirring bar and a stainless steel heating/cooling coil which also acts as the anode for electrodeposition.

The coat out properties were:
Bath temperature: 90° F.
Voltage: 200-250 volts
Amperage: 0.7-1.0 amps
Coating time: 2 minutes

The panel, now coated with the electrodeposited composition, was removed from the bath and rinsed with a spray of deionized water, hung vertically to drain away excess water, then baked for 30 minutes at a temperature of 400° F. in an electric oven.

### Part E: Comparison of Flatting Ability on an L Panel

The 4 inches×12 inches ACT panels were bent widthwise about 2 inches from the bottom to form an “L” shape. In turn, an “L” panel was placed in a paint bath and the agitation was stopped for 3 minutes. Next, 70% of the usual coat-out voltage was applied for 1 minute with the agitation still off. After rinsing with deionized water and a 30 minute bake at 400° F. (about 205° C.) in an electric oven, the 60° gloss and profile on the top versus the bottom of the horizontal portion of the “L” were determined. The results were as follows:

| | Gloss | | Gloss | |
|---|---|---|---|---|
| | top side | Profile | bottom side | Profile |
| Conventional flat coating | 1.1 | 327 μ in. | 21.0 | 12 μ in. |
| (From Part C Above) | | | | |
| Coating without silica | 1.9 | 168 μ in. | 2.4 | 150 μ in. |
| (From Part B Above) | | | | |

The testing thus confirmed that panels coated with an electrodepositable coating composition having the flatting agent dispersion formed in accordance with the present invention achieved a 60° gloss of less than 3 on the top side and bottom side of the L-shaped panel at conventional film builds. The testing also confirmed that this result was achieved without the need for continuous agitation of the electrodepositable coating composition in the bath, which appears to be required in electrodepositable coating compositions using traditional flatting agents.

### Example 2

### Preparation of a Second Flatting Agent Dispersion and Electrodepositable Coating Composition

This example describes the preparation of a cationic electrodepositable coating composition with another flatting agent resinous dispersion in accordance with the present invention.

### Part A: Preparation of Flatting Agent Dispersion

A 3000 ml round-bottomed flask was charged with 515.3 parts (2.74 equivalents) of bisphenol A diglycidyl ether, 156.6 parts (1.37 equivalents) of bisphenol A, 105.8 parts (0.23 equivalents) of an adduct prepared as a 1:2 molar ratio adduct of polyol and hexahydrophthalic anhydride, where the polyol itself is a 1:9 molar adduct of bisphenol A and ethylene oxide (available from BASF Surfactants as Macol RD 209), and 40.9 parts of methyl isobutyl ketone. The flask was then equipped with a motorized stirrer, a condenser, a heating mantle, and a thermocouple probe. Under a nitrogen blanket, the mixture was heated to 70° C., at which point 0.8 parts of ethyl triphenylphosphonium iodide (available from Sigma-Aldrich) was added and heating was continued to initiate an exotherm. The reaction mixture was held at 165° C. or above (exotherm peak temperature) for one hour. The mixture was then cooled to 80° C. as 318.8 parts of methyl isobutyl ketone was added. At 80° C., 34.4 parts (0.46 equivalents) of N-methylethanolamine, 3.5 parts (0.11 equivalents) of ethanolamine, and 23.9 parts (0.47 equivalents) of 3-dimethylaminopropylamine (0.47 equivalents) were added. The resulting mixture was held at 112° C. for 90 minutes, then 800 parts of this mixture was poured into an agitated solution of 57.3 parts (0.59 equivalents) of sulfamic acid in 429.0 parts of room-temperature deionized water. About 15 minutes later, 252.1 parts (1.34 equivalents) of bisphenol A diglycidyl ether was blended in. After 30 minutes, a total of 5705.4 parts of additional deionized water was added. This fluid dispersion was heated to 60° C. and a vacuum was applied to remove the methyl isobutyl ketone over about 2 hours. The dispersion was then heated at atmospheric pressure to 80° C. and held there for 2 hours. Deionized water was added to return the dispersion to its original solids content. Finally, this dispersion was then transferred to a hot room maintained at 71° C. and kept there for 3 days. The dispersion was milky, fluid, and evidenced a 1 hour at 110° C. solids content of 12.7%.

A version of this flatting agent, in another embodiment, can also be prepared in 2-butoxyethanol in place of methyl isobutyl ketone, using the amines to catalyze the reaction. The advantage of this approach is that the dispersion can be made at 27% solids content and the solvent stripping and hot room aging can be omitted, but the stability of this version of the flatting agent is reduced.

Part B: Preparation of Electrodepositable Coating Composition with Flatting Agent

The electrodepositable coating composition was prepared from a mixture of the following ingredients:

| | | |
|---|---|---|
| Resin blend ¹ | 1,191.9 | g |
| Flatting Agent Dispersion (Example 2, Part A) | 579.4 | g |
| Flow Additive ² | 62.3 | g |
| Pigment paste ³ | 398.7 | g |
| Deionized water | 1,567.7 | g |

¹ Cationic resin blend commercially available as CR935 from PPG Industries, Inc.
² Commercially available as CA147 from PPG Industries, Inc.
³ A pigment paste commercially available as CP982 from PPG Industries, Inc.

The electrodepositable coating composition was prepared by charging resin blend and predispersing it in deionized water. Next, the cationic flatting agent dispersion (from Example A) was added under agitation and stirred until uniform to create this resin blend. Next, the flow additive was added under agitation and stirred until uniform. The pigment paste was then predispersed using deionized water in a separate container. After stirring for several minutes to create a diluted, uniform, low viscosity paste blend, it was added to the resin blend under agitation and stirred until the coating composition has become uniform. Thirty percent by weight of the coating composition was removed by ultrafiltration and replaced by deionized water, therein forming the electrodepositable coating composition.

Part C: Preparation of Electrodepositable Coating Composition without Flatting Agent

An electrodepositable coating composition was prepared from a mixture of the following ingredients:

| | | |
|---|---|---|
| Resin blend¹ | 1,509.8 | g |
| Flow Additive² | 62.3 | g |
| Pigment paste³ | 398.7 | g |
| Deionized water | 1 829.2 | g |

¹Cationic resin blend commercially available as CR935 from PPG Industries, Inc.
²Commercially available as CA147 Flow Additive from PPG Industries, Inc.
³A pigment paste commercially available as CP982 from PPG Industries, Inc.

The electrodepositable coating composition of Part C was prepared with the same ingredients and in substantially the same manner as Part B of Example 2, but without the flatting agent dispersion from Part A of Example 2. The resultant P/B ratio and percent solids in the coating composition of Part B above and Part C of Example 2 were 0.151 and 15%, respectively.

### Part D: Coating Parameters and Panel Type Used for Coat Outs

The steel panels used for the electrocoating of this paint formulation are available from ACT Test Panels LLC of Hillsdale, Mich. as part number APR33225.

The panels are ACT Cold Roll Steel and are 4 inches×12 inches×0.032 inches. They are prepared with B952 P90 DIW.

The cylindrical plastic coating tube 4¾ inches diameter and 15 inches height was equipped with a magnetic stirring bar and a stainless steel heating/cooling coil which also acts as the anode for electrodeposition.

The coat out properties were:
Bath temperature: 90° F.
Voltage: 200-250 volts
Amperage: 0.7-1.0 amps
Coating time: 2 minutes

The panel, now coated with the electrodeposited composition, was removed from the bath and rinsed with a spray of deionized water, hung vertically to drain away excess water, then baked for 30 minutes at a temperature of 400° F. in an electric oven. A hard and smooth organic coating resulted with a film thickness of 0.85 mils, or 0.0085 inches.

60° gloss readings were then measured on panels coated with either the coating composition of Part B or the coating composition of Part C from above. The results were as follows:

| | 60° Gloss |
|---|---|
| Coating with Flatting Agent | 2.8 |
| (From Part B Above) | |
| Coating without Flatting Agent | 32 |
| (From Part C Above) | |

The testing thus confirmed that panels coated with an electrodepositable coating composition having the flatting agent dispersion formed in accordance with the present invention achieved a 60° gloss of less than 3 at conventional film builds, while panels without the flatting agent dispersion, but otherwise identical, did not achieve such a flatting effect.

Whereas particular embodiments of the invention have been described hereinabove for purposes of illustration, it will be evident to those skilled in the art that numerous variations of the details of the present invention may be made without departing from the invention as defined in the appended claims.

We claim:

1. A resinous dispersion suitable for use in an electrodepositable coating composition, the resinous dispersion comprising:
(a) an epoxy-amine adduct comprising the reaction product of reactants comprising:
(i) an epoxy-containing compound having at least one active hydroxyl group; and
(ii) an amine-containing compound having a primary and a tertiary amine group;
(b) an acid;
(c) a second epoxy-containing compound; and
(d) water.

2. The resinous dispersion of claim 1, wherein said epoxy-containing compound having at least one active hydroxyl group (i) comprises an epoxy-containing compound according to Formula (I): 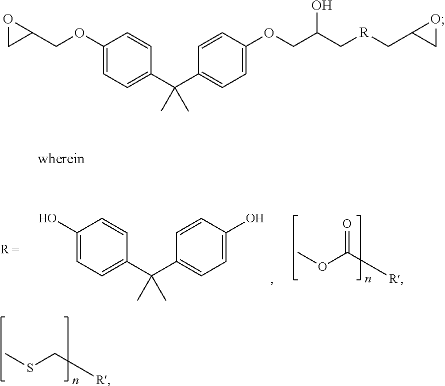
and/or combinations thereof;
R′ is aliphatic, cycloaliphatic and/or aryl and comprises an ester, a urethane and/or ether linkage; and
n is from 1 to 3.

3. The resinous dispersion of claim 1, wherein said amine-containing compound (ii) comprises dimethylaminopropylamine, 2-dimethylaminoethylamine, 4-dimethylaminobutyl-amine, 6-dimethylaminohexylamine, and/or dimethylaminomethylaniline.

4. The resinous dispersion of claim 1, wherein said amine-containing compound (ii) comprises from 0.4 to 7.0 weight percent based on resin solids of the resinous dispersion.

5. The resinous dispersion of claim 1, wherein said epoxy-amine adduct (a) and said second epoxy compound (c) form micelles that are dispersed in said water having a relative gel fraction of at least 88% after heat aging.

6. The resinous dispersion of claim 1, wherein the epoxy-amine adduct further comprises (iii) a reactant comprising at least one additional amine-containing compound.

7. The resinous dispersion of claim 6, wherein said at least one additional amine-containing compound comprises N-methylethanolamine, ethanolamine, diethanolamine, morpholine, 3-methoxy-1-propylamine, 4-methyl-2-pentanone diketimine of diethylenetriamine, aniline, and combinations thereof.

8. The resinous dispersion of claim 1, wherein the said epoxy-containing compound having at least one active hydroxyl group (i) comprises the reaction product of reactants comprising a diepoxide and an adduct, wherein said adduct comprises the reaction product of reactants comprising a polyol and an anhydride of a diacid.

9. The resinous dispersion of claim 8, wherein said anhydride of a diacid comprises hexahydrophthalic anhydride, maleic anhydride, succinic anhydride, phthalic anhydride, and combinations thereof.

10. The resinous dispersion of claim 1, wherein the epoxy equivalent weight of said epoxy-containing compound (i) is from 400 to 1300 based on resin solids.

11. The resinous dispersion of claim 1, wherein the epoxy equivalent weight of said epoxy containing compound (c) is from 168 to 1000 based on resin solids.

12. The resinous dispersion of claim 1, wherein said epoxy containing compound (c) comprises bisphenol A diglycidyl ether.

13. An electrodepositable coating composition comprising the resinous dispersion of claim 1 and further comprising a cationic curable film-forming binder, a curing agent and, optionally, a colorant.

14. The electrodepositable coating composition of claim 13, wherein said curing agent comprises a blocked or unblocked isocyanate containing compound.

15. The electrodepositable coating composition of claim 13, wherein said cationic curable film-forming binder comprises an acrylic polymer comprising sulfonium salt groups.

16. A coated substrate formed from the electrodepositable coating composition of claim 13.

17. The substrate of claim 16, wherein the substrate is a multi-sided coated substrate, wherein each side of said multi-sided coated substrate has a 60 degree gloss reading measured at 3 or less.

18. A resinous dispersion suitable for use in an electrodepositable coating composition, the resinous dispersion comprising:
(a) an epoxy-amine adduct according to Formula (II): 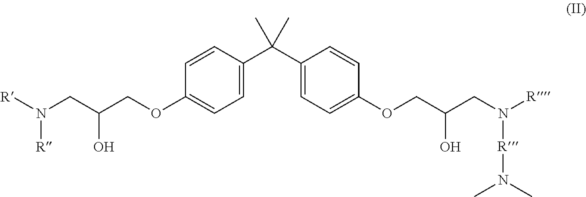
wherein
R′ is H, —CH₂—CH₂—OH, —CH₂—CH(CH₃)—OH, —CH₂CH₂NH₂, or —(CH₂)_{R1}CH₃, where R1 is from 0 to 9;
R″ is —CH₂—CH₂—OH, —CH₂CH₂NH₂, or —CH₂—CH(CH₃)—OH;
R″′ is —(CH₂)_{R2}CH, where R2 is from 1 to 9; and
R″″ is R′, R″ or 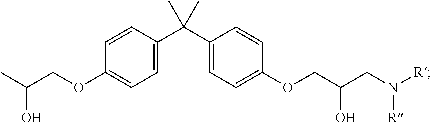
(b) an acid;
(c) an epoxy-containing compound different from (a); and
(d) water.

19. An electrodepositable coating composition comprising the resinous dispersion of claim 18 and further comprising a cationic curable film-forming binder, a curing agent and, optionally, a colorant.

20. A multi-sided coated substrate formed from the electrodepositable coating of claim 18, wherein each side of said multi-sided coated substrate has a 60 degree gloss reading measured at 3 or less.
